(19) United States
(12) Patent Application Publication
(10) Pub. No.: US 2013/0038143 A1
(43) Pub. Date: Feb. 14, 2013

(54) SYSTEM AND METHOD WITH ZERO POWER STANDBY MODE FOR CONTROLLING AN ELECTRIC APPARATUS

(71) Applicant: NATIONAL SCIENCE AND TECHNOLOGY DEVE, Prathumthani (TH)

(72) Inventors: Thaweesak Koanantakool, Prathumthani (TH); Patharakorn Rattanawan, Prathumthani (TH); Matanee Kitjaroen, Prathumthani (TH); Pornanong Pongpaibool, Prathumthani (TH); Siwaruk Siwamogsatham, Prathumthani (TH)

(73) Assignee: NATIONAL SCIENCE AND TECHNOLOGY DEVELOPMENT AGENCY, Prathumthani (TH)

(21) Appl. No.: 13/654,776

(22) Filed: Oct. 18, 2012

Related U.S. Application Data
(63) Continuation of application No. PCT/TH2011/000009, filed on Apr. 21, 2011.

(30) Foreign Application Priority Data
Apr. 22, 2010 (TH) 1001000646

(51) Int. Cl. H02J 1/00; H02M 7/02

(52) U.S. Cl. 307/143; 363/84

(57) ABSTRACT

A zero power standby system for controlling electric appliances is able to wait for switch on instructions without any power consumption. This is done by a remote controller (1) transmitting power in the form of an electromagnetic field, light, or audio signal to a power receiving section (2) of a control signal receiving device (13). The power receiving section will then use the received power to force a multi-switch section (7) to connect between a power supply and a control signal receiving section (9) and a control signal processing section (3) and put the appliance into its usual running mode. When a user desires to turn off the electric appliance, the system stops supplying power to the control signal receiving section (9) and the control signal processing section (3) by turning off multi-switch section (7) and putting the electric appliance back to its zero power standby mode (i.e. consuming no power). Therefore, wasting of electrical energy in the standby mode is reduced to zero.

### CROSS REFERENCE TO RELATED APPLICATION

The present application is a continuation application of International Application No. PCT/TH2011/000009 filed Apr. 21, 2011, entitled “System with Zero Power Standby Mode for Controlling Electric Apparatus”, which claims priority from Thai Patent Application No. 1001000646 filed Apr. 22, 2010, the disclosures of both priority applications expressly incorporated by reference herein in their entirety.

### FIELD OF THE DISCLOSURE

The disclosure relates generally to a system and a method with zero power standby mode for controlling electric appliances.

### BACKGROUND

Demands for power consumption among humans are currently increasing; however, available natural power decreasing. Therefore, humans are now trying to search for new substituted power sources and inventing new technologies to save the power. The standby mode is a type of technologies that has been invented to meet the objective in power saving and provide comfort and convenience in operating electric appliances. At present, the standby mode is widely available in the electric appliance such as televisions, stereo components, air conditioners etc. After each usage of such appliances, users usually turn off the appliances via remote controls. Being turned off by the remote controls, the electric appliances enter their standby mode, which, in turn, allows the appliances to continue consuming some electric power. This is due to the fact that the standby mode requires some electric power to run sensor circuits that continuously await instructions from the remote controllers to turn the appliances back on.

Therefore, there have been attempts to invent the standby mode without any waste of power to reduce the power consumption for such electric appliances.

The present invention relates to the standby mode. For example, the US Patent Application Serial No. 2007/0279951 by Chin-Hsiang Wu of Taiwan disclosed a standby mode for electric appliances that is operated by supplying power to signal sensor during the standby mode. This mode, however, still requires the power supplied to the signal sensor.

The U.S. Pat. No. 5,414,475, titled “Method of operating a low standby power system for a television receiver” issued to William A. Trzyna, Elgin; Carl E. Welding, Barrington, Ill., USA discloses that a large capacitor is provided for storing backup power to be supplied to microprocessors and infrared receiving devices in the standby mode and the capacitor is recharged when there is a voltage drop in the capacitor. The said method reduces the power consumption of the standby mode system in television sets. However, the system according to the U.S. Pat. No. 5,414,475 still consumes some amount of power.

The U.S. Pat. No. 4,500,923, titled “Television receiver standby power supply” issued to William E. Duvall; Mau-Choung P. Hwang, Indianapolis, USA, discloses a conventional standby system used in television sets. In its standby mode, remote control circuits require a continuous supply of power and thus consuming the electric power.

The U.S. Pat. No. 6,414,864, titled “Circuit for reducing standby power of electrical apparatus” by LG Electronics, Inc., Republic of Korea discloses a circuit for reducing standby power. However, the circuit still supplies the power to a control instruction receiving device, diode, and microcomputer, which resulted in a power consumption in its standby mode in the range of approximately 10-15 milliwatts similar to that disclosed in the U.S. Pat. No. 6,307,762, titled “Power supplying circuit and method” that still requires 20 milliamperes of the electrical current for an optical remote control circuit and microcontroller in the standby mode.

### SUMMARY OF THE DISCLOSURE

In order to eliminate the drawback of power consumption in the standby mode outlined above, a system for the zero power standby mode for the electric appliances has been developed. The objective of the present invention is to minimize the power consumption in the standby mode. The developed standby mode does not consume any energy while the system is in the standby mode. When the user switches on the electric appliances, the system then uses the power transmitted from the remote controller to control a switching circuit to electrically connect the power supply to a control signal receiving section and a processing section or a microcontroller. The system may delay the time until the control signal receiving section and the processing section start to function before sending out the control signal. Thus it will allow a user to control an operating mechanism of the electric appliance that will enter its usual running mode.

The zero power standby system for the electric appliances according to the present invention is capable of awaiting a switch on signal with having no need for any quiescent current. This is done by the remote controller sending the power in form of any one of either electromagnetic field, light, or audio signals to a power receiving section of the control signal receiving device. The power receiving section will then use the input power received to control a multi-switch section to switch on/off the supply of quiescent current to the control signal receiving section and the control signal processing section and start its running mode. When the user switches off the electric appliance, the control section cuts off the power supplied to the control signal receiving section and the control signal processing section , the electric appliance will then enter its standby mode without any power consumption. It is thus possible to reduce wasting of the electrical power in the standby mode, the power consumption, and expense on the power.

### BRIEF DESCRIPTION OF THE DRAWINGS

FIG. 1 shows a block diagram of the zero power standby system for the electric appliances according to the present invention.

FIG. 2 shows a block diagram of the remote controller for use with the zero power standby system for the electric appliances.

FIG. 3 shows a block diagram of an operational means of the power receiving device according to the present invention.

FIG. 4 shows an example of the switching circuit that controls the power supply to the control instruction receiving section and the control signal processing section.

FIG. 5 shows an example of the circuit of the control signal processing section.

FIG. 6 shows working steps of the system according to the present invention.

### DETAILED DESCRIPTION

The description of the present invention is made by exemplification of the invention and reference to the exemplary drawings. For the better understanding, the same members in these drawings are designated with the same reference numbers. Without any limitation, the scope of the present invention is defined in the appended claims.

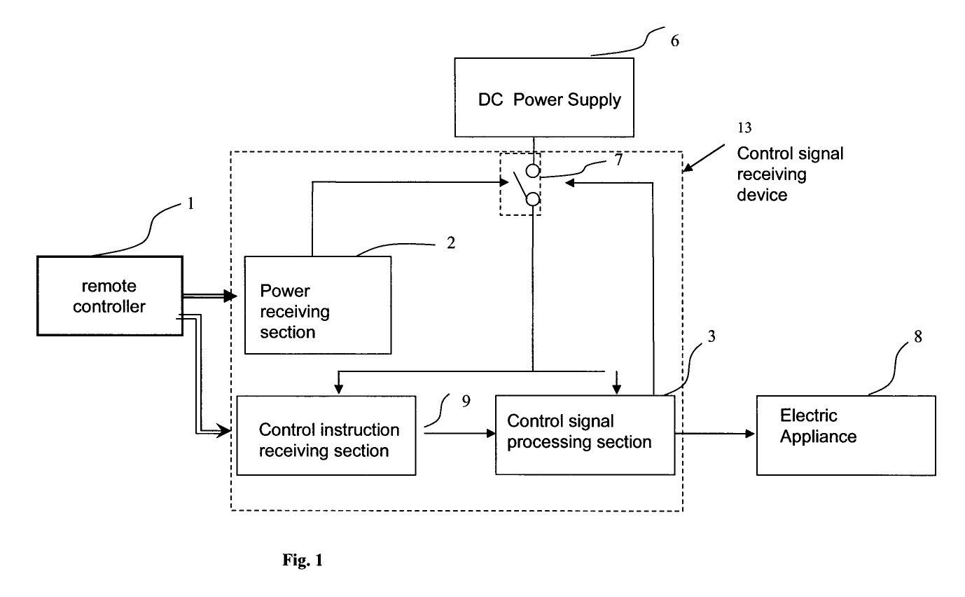

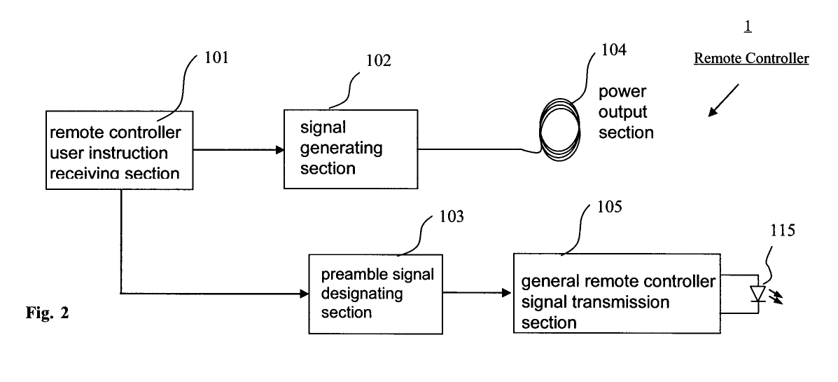

A zero power standby system for electric appliances according to the present invention is shown in FIG. 1. The system comprises a remote controller (1) and a control signal receiving device (13) operatively connected to the electric appliance. control signal receiving device (13) includes a power receiving section (2) for receiving activating power or wake up signal from the remote controller (1) and generating a waking up command upon receiving the activating signal; a control instruction receiving section (9) for receiving a control signal from the remote controller (1) such as infrared or radio frequency signal, etc.; a control signal processing section (3) for controlling the electric appliance in response to the control signal from the remote controller, and a multi-switch section (7), in response to a waking up command from the power receiving section (2) , supplies power to the control signal processing section (3) and the control instruction receiving section (9) and in present of control signal from the control signal processing section (3), continues to supply power to the the control signal processing section (3) and the control instruction receiving section (9) until the user turns off the power. The system is supplied by a direct current supply (6), which may be an external power supply such as a battery, a solar cell, a large capacitor, or a AC/DC transformer. The power supply is connected via the multi-switch section (7) to supply electric power to the control signal processing section (3) and the control instruction receiving section (9). The control signal receiving device (13) may be connected to an external direct current supply (6) or may be incorporated in the electric appliances in order to control operations of the electric appliance (8) such as a television set, VCR player, VCD player, radio, and the like. Typically, these appliances can operate in either of two modes i.e. a running mode and a standby mode. In the standby mode, the electric appliance is turned off and keeps waiting for a control signal (wake up signal) from the remote controller without consuming any electrical power during the standby mode.

The remote controller (1) comprises a power output section (104) for outputting an activating signal, and a control signal output section (105, 115) for outputting a control signal to the electric appliance that can operate in either a standby mode or a running mode.

The following describes operation of the system according to the present invention in details.

According to FIG. 1, while the system is in its zero power standby mode, a user can press a button on the remote controller (1) in order to turn on the electric appliance (8) as he or she desires. The user may do so by pressing the “on” button on the remote controller (1) to activate the remote controller (1) to transmit an waking up signal i.e. energy wave, such as electromagnetic wave, visible or invisible light, or ultrasonic sound wave, or the like, to the power receiving section (2). The power receiving section (2) comprises a power receiving means, such as an antenna, a photocell or a piezoelectric, and the like, such that the power receiving means uses power it receives from the remote controller (1) to activate the multi-switch section (7). The multi-switch section (7) then forces the direct current supply source (6) to supply DC power to the control signal processing section (3) and the control instruction receiving section (9) so that the control signal receiving device (13) can wake up and function normally. The remote controller (1) then transmits a control signal, for example, infrared light, radio signal, ultrasonic and the like with the predetermined protocol and frequency known in the art, for example, RC-5, RC-6, SIRCS, or NEC TC101 or the like, to transmit an infrared light command to the electric appliance to the control instruction receiving section (9). The control signal processing section (3) may include a means to detect whether or not the received control instruction signal conforms with the predetermined format for activating the appliance. If the control signal transmitted to the control instruction receiving section (9) complies with the predetermined signal format for activating the appliance, the control signal processing section (3) then connects the controlled electric appliance (8) to the main power supply (not shown). This will enable the system to remain in the usual running mode. Otherwise, the control signal processing section (3) puts the system back into the zero power standby mode.

In case that the system is in its usual running mode, when the user transmits any instructions from the remote controller (1) to the control signal receiving device (13), the remote controller (1) will then transmit only the predetermined control instruction signal for the particular instructions to the control instruction receiving section (9) only. But the remote controller (1) need not transmit any wake up signal or power to the power receiving section (2), when the user wants to turn off the electric appliance and bring the system back to its zero power standby mode. This can be done by pressing the on/off button at the remote controller (1) and the predetermined control instruction signal for switching off the electric appliance will then be transmitted to the control instruction receiving section (9). The control signal processing section (3) will then transmit the instructions to turn off the electric appliance and to operate the multi-switch section (7) to cut off a circuit connection. The power from the direct current supply section (6) is consequently no longer supplied to the control instruction receiving section (9) and the control signal processing section (3). The system is, therefore, turned off. At this time, the system immediately enters into its zero power standby mode. The power receiving section (2) is the only part that can be readily activated without any need for quiescent current due to the fact that this power receiving section (2) is self-operational by using the power from the remote controller (1) to turn on the system and resume to its running mode as described above.

The direct current supply section (6) is the direct current supply source for supplying the power to the control instruction receiving section (9) and the control signal processing section (3) in the running mode. The electric power may be received from a capacitor, a battery, a solar cell, or a AC/DC transformer, or the like.

FIG. 2 shows a detailed schematic diagram of the remote controller (1) according to the invention. The remote controller (1) includes a remote controller user instruction receiving section (101), a signal generating section (102), a preamble signal designating section (103), a power output section (104), and a general remote controller signal transmission section (105) that generates a control signal to be outputted via an infrared diode(s). (115)

The principle of operations is now described. When the user presses an “on” button (not shown) on the remote controller (1) to send an instruction to switch on the electric appliance, which may be done by pressing the on/off button. The remote controller user instruction receiving section (101) then enables the signal generating section (102) to generate a signal that will then be transmitted through the power output section (104) to the power receiving section (2) in the electric appliance as described in FIG. 1 While the user presses the on/off button to activate/deactivate the remote controller user instruction receiving section (101), the signal from the remote controller user instruction receiving section (101) at the remote controller (1) will then be transmitted to the preamble signal designating section (103) which, in turn, may use a delay means to enable a delay for an amount of time, for example, 10 milliseconds for the power output section (104) to output the power to activate the control instruction receiving section (9) and the control signal processing section (3) in advance. Once the delay time is elapsed, the general remote controller signal transmission section (105) then outputs the control instruction signal via the infrared diode (115). Furthermore, instead of the delay means, the preamble signal designating section (103) may also use other means to output any formats of signals for a certain amount of time before outputting the designated instruction signal.

In case the remote controller uses a means to sense the on/off instructions from the remote controller user by use of only one on/off button, the remote controller user instruction receiving section (101) may include a means to acknowledge that the remote controller (1) is in the on or off status by verifying output of other instructions other than the on/off instructions other than the on/off instructions. For example, after the user presses the “on/off” button on the remote controller, if other buttons than “on/off” button are pressed more than the predetermined times, it can be assumed that the “on/off” button is in the “on” state. If the “on/off” button on the remote controller (1) is pressed one more time, the instruction receiving section will then be informed that it is the switch off instruction and the remote controller (1) will not output the power from the power output section (104). Instead, it will transmit the switch off instructions via the general remote controller signal transmission section (105).

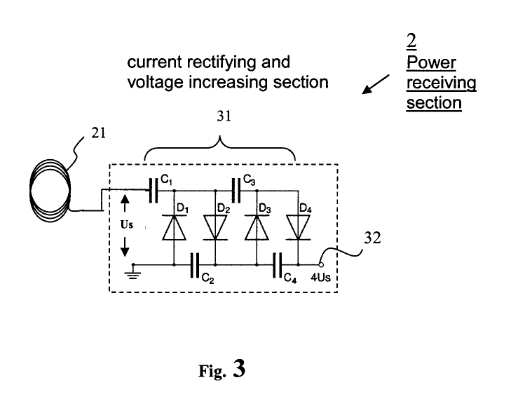

FIG. 3 shows a block diagram of an operational means of the power receiving section (2). The power receiving section (2) comprises a power receiver (21) that may be connected to a current rectifying and voltage increasing section (31) to generate an activating signal (32) with a voltage of approximately 1-5 volts. The operational principle for this is that, when the power is received at the power receiver (21), for example, a coil or a metal strip, an alternating current is generated and forwarded to the current rectifying and voltage increasing section (31) to increase the voltage. The current rectifying and voltage increasing section (31) is a means used in converting the alternating current into the direct current and/or a means used in increasing the voltage. Additionally, the current rectifying and voltage increasing section (31) may both convert the alternating current into the direct current and increase the voltage. FIG. 3 shows a half-wave voltage expanding circuit comprising diodes (D1-D4) and capacitors (C1-C4). The voltage from the power receiver (21) is converted into an direct current and increased four times. For example, a voltage level (Us) from the power receiver (21) with the maximum value of approximately 0.5 volts is increased to 2 volts. The voltage or the activating signal (32) will then be transmitted to the multi-switch section (7) which will later be described.

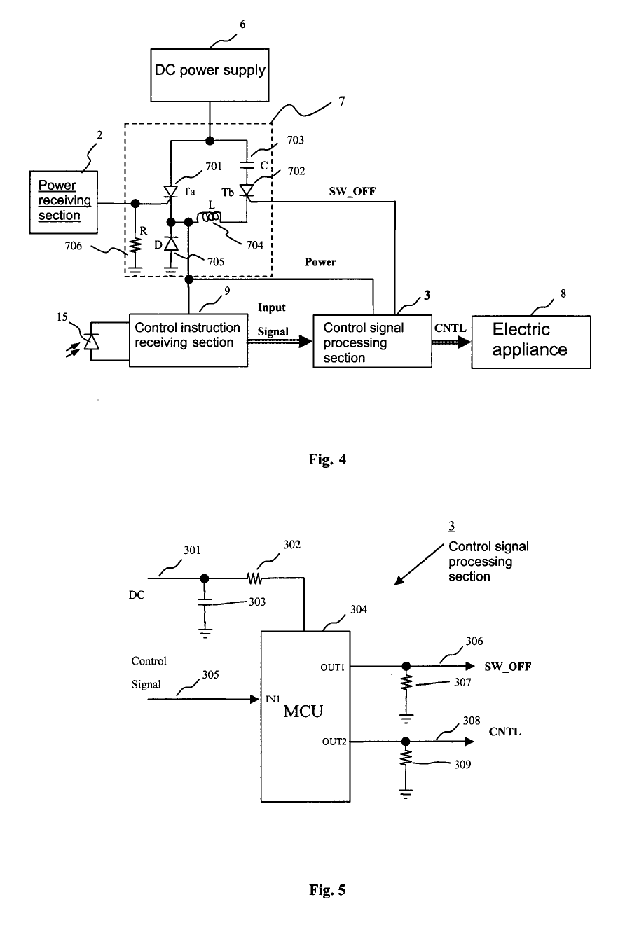

FIG. 4 shows an example of a means and an example of the power supply control switching circuit for the control instruction receiving section (9) and the control signal processing section (3). The operational principle is that, when the user wants to switch on the electric appliance by pressing the on/off switch, the remote controller user instruction receiving section (101) will receive the power from the power output section (104) and the switch on control instruction signal from the remote controller (1) via the diode (115) to the power, receiving section (2) and the control instruction receiving section (9) respectively. The power receiving section (2) then transmits the activating signal whose current and voltage have been rectified and increased to the multi-switch section (7). This will enable the switch, which, in this example, is the first conductive thyristor (SCR) (701) to receive the electric power from the direct current supply section (6) to be supplied to the control instruction receiving section (9) and the control signal processing section (3) and the control instruction signal to switch on the electric appliance will be received by the control instruction receiving section (9) to be processed under a signal sensing means (15). The signal will then be transmitted to the control signal processing section (3), which, in turn, will process the signal and transmit the control signal (CNTL) to switch on the electric appliance (8) to operate in the running mode.

After the electric appliance starts functioning in the usual running mode, when the user switches off the electric appliance (8) by pressing the on/off button at the remote controller user instruction receiving section (101), the switch off control instruction signal is received by the control instruction receiving section (9) and forwarded to the control signal processing section (3). The control signal processing section (3) then processes the signal. When the switch off instruction is acknowledged, the control signal processing section (3) transmits a pulse signal (SW OFF) to activate the second SCR (702). When the second SCR (702) is activated, there will be a current running through the capacitor C (703) and through the second SCR (702) to an inductor L (704). This will stop conduction of the first SCR (701). When the capacitor C (703) is fully charged, the second SCR (702) will also stop conducting the current. The multi-switch section (7) thus stops functioning and there will be no supply of the electric power from the direct current supply section (6) to the control instruction receiving section (9) and the control signal processing section (3). The system will then stop as described above.

It can be seen that the system enters the standby mode without any power consumption. The system will supply the electric power to the control instruction receiving section (9) and the control signal processing section (3) only when the multi-switch circuit (7) is closed. The multi-switch circuit (7) will start functioning only when the power receiver (21) receives the power from the remote controller (1). Therefore, from the operational principle, the invented system consumes no power during its standby mode.

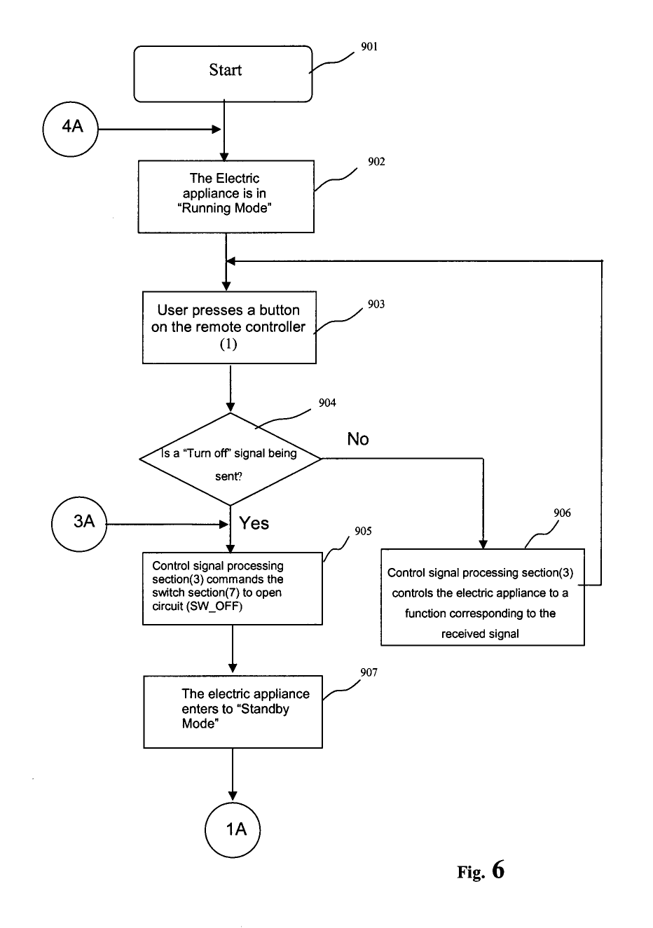

FIG. 5 shows an example of the circuit of the control signal processing section (3). The direct current power supply (6) will supply the power for use as the quiescent current for the circuit of the control signal processing section (3) along the line (301), when the power receiving section (2) receives the power from the remote controller (1) and instructs the multi-switch section (7) to close the circuit. The resistor (302) and the capacitor (303) will limit the current and filter the current before supplying to the control signal processing section (3). The control signal processing section (3) comprises a microcontroller (304) that processes the control signal received from the control instruction receiving section (9). The signal is inputted at an input end IN1 (305) of the microcontroller. The signal (CNTL), as a result of the processing result, will be outputted to control the electric appliance at an output end OUT2 (308).

The signal controlling the multi-switch circuit (7) is outputted as the switch control signal (SW_OFF) at an output end OUT1 (306). The signal (SW_OFF) is outputted to control the second thyristor (702) to conduct the current for the multi-switch section (7) to open the circuit in case the user presses the “off” button at the remote controller (1) as described above.

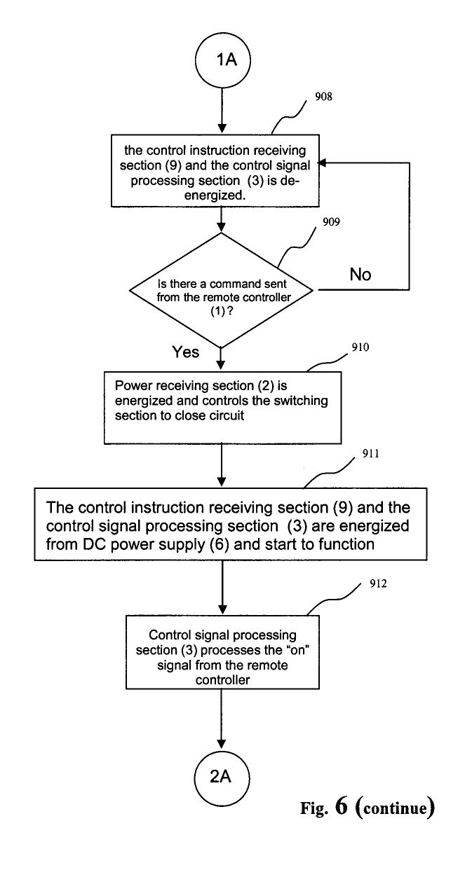

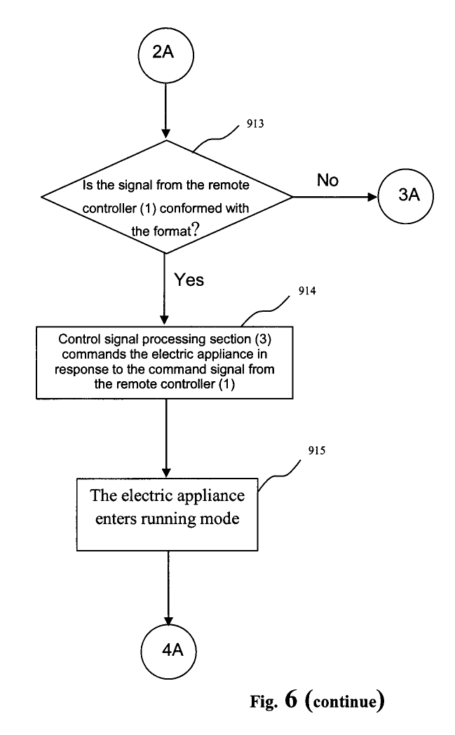

FIG. 6 shows working steps of the system according to the present invention. According to FIG. 6, when the system starts (step 901) and the electric appliance is in an on state (step 902) when the user transmits the instructions at the remote controller (1) (step 903), the signal from the remote controller (1) will be transmitted to the control instruction receiving section (9) in the electric appliance and forwarded to the control signal processing section (3). The control signal processing section (3) then processes to determine whether the signal is the switch off signal for the electric appliance or not (step 904). If not, the control signal processing section (3) then controls the electric appliance in accordance with the signal from the remote controller (1) (step 906). The system then returns to wait for the user to send another instruction from the remote controller (1) (step 903). If the result of the process to determine whether the signal is the switch off signal for the electric appliance or not is affirmative, the control signal processing section (3) then transmits the instruction to control the multi-switch section (7) to open the circuit (step 905). The electric appliance will then immediately enter the standby mode (step 907).

According to FIG. 6, when the electric appliance is in the standby mode, the control signal receiving section (9) and the control signal processing section (3) will stop functioning since the electric power supplied to them is cut by the multi-switch section (7) (step 908). In this step, the system will be in the standby mode without any power consumption. This is, therefore, a saving of consumed power.

The remote controller (1) will output the power and the switch on signal only if the user transmits the “on” instructions by pressing the button at the remote controller (1) (step 909). Once the power receiving section (2) receives the outputted power, it controls the multi-switch section (7) to close the circuit (step 910). As a result, the control signal processing section (3) and the control instruction receiving section (9) receive the quiescent current from the power supply section (6) and start functioning (step 911) and resume their operations. The control signal processing section (3) is, therefore, enabled to process the switch on signal (step 912) to determine whether it is the switch on signal from the remote controller (1) in association with the electric appliance or not (step 913). This will prevent the electric appliance, from inadvertently leaving the standby mode as a result of a noise signal or a remote signal from another remote controller, etc.

If the result of the above determination is “Yes”, the control signal processing section (3) will then transmit the control signal for the electric appliance from the remote controller (1) (step 914) wherein the electric appliance is currently leaving its standby mode and entering the usual running mode (step 915). If, on the other hand, the processing to find out whether it is the switch on signal from the remote controller (1) in association with the electric appliance or not (step 913) shows the result “No”, the control instructions processing section (3) will then transmit the instructions to control the multi-switch section (7) to open the circuit (step 905) and the system will operate as described above.

As described above, the invention in accordance with this application has shown the zero power standby mode for the electric appliance, which is able to minimize the power consumption in its standby mode. The standby system according to the present invention does not use the power while in its standby mode. Once the user switches on the electric appliance, the system will use the power outputted from the remote controller to control the switching circuit to connect the power supply to the control signal receiving section and the processing section or the microcontroller. The system may delay the time until the control signal receiving section and the processing section start to function before sending out the control signal. Thus it will allow the user to control the operating mechanism of the electric appliance that will enter its usual running mode.

The zero power standby system for the electric appliances according to the present invention is capable of awaiting the switch on signal with having no need for the quiescent current. This is done by the remote controller sending the power in the form of any one of either electromagnetic field, light, or audio signal to the power receiving section of the control signals receiving device. The power receiving section will then use the input power to control the multi-switch section to switch on/switch off the supply of power to the control signal receiving section and the control signal processing section and start its running mode. When the user switches off the electric appliance, the power supply to the control signal receiving section and the control signal processing section is then cut and the appliance will enter its standby mode without any power consumption. It is thus possible to reduce wasting of the electrical power in the standby mode, the power consumption, and the expense on the power.

Although the present invention has been fully described along with the exemplary accompanying drawings, it is to be understood that the modifications or variations can be made by those with ordinary skills in the related arts within the scope and spirit of the invention. The scope of the present invention shall be in accordance with the invention defined in the attached claims and include the aspects of the invention not specifically defined in the claims but yield the utility and implementation in the similar way to those in the invention as defined in the claims.

1. A system with a zero power standby mode for controlling an electric appliance, the system comprising:
a remote controller comprising a power output section for outputting an activating signal, and a control signal output section for outputting a control signal for controlling the electric appliance; and
a control signal receiving device operatively connected to the electric appliance, the control signal receiving device comprising:
a power receiving section having a means for receiving the activating signal from the remote controller and generating a waking up command upon receiving the activating signal;
a control instruction receiving section for receiving the control signal output from the remote controller; and
a control signal processing section for controlling the electric appliance in response to the control signal from the remote controller,
wherein upon receiving the activating signal from the remote controller, the power receiving section generates the waking up command so that the control signal processing section and the control instruction receiving section are waked up and supplied with electric power, thereby the system is ready for receiving the control signal from the remote controller, and
wherein the power receiving section is configured to be readily activated using the power transmitted by the activating signal without any need for a quiescent current.

2. A system with a zero power standby mode for controlling an electric appliance according to claim 1, wherein the remote controller transmits the control signal to enable the electric appliance connected to the control signal receiving device to operate after the activation of the control instruction receiving section and the control signal processing section.

3. A system with a zero power standby mode for controlling an electric appliance according to claim 1, wherein the power receiving section includes an electromagnetic wave receiving means for receiving an electromagnetic wave signal transmitted from the remote controller as the activating signal.

4. A system with a zero power standby mode for controlling an electric appliance according to claim 1, wherein the power receiving section further comprises a rectifier and a voltage doubler circuit connected, in series, to the activating signal receiving means.

5. A system with a zero power standby mode for controlling an electric appliance according to claim 1, the control instruction receiving section being an infrared signal receiving section.

6. A system with a zero power standby mode for controlling an electric appliance according to claim 1, the remote controller further comprising a power output means for outputting power, as the activating signal, to energize the power receiving section of the control signal receiving device.

7. A system with a zero power standby mode for controlling an electric appliance according to claim 6, the power output means including an antenna.

8. A system with a zero power standby mode for controlling an electric appliance according to claims 6, the power output from the power outputting section of the remote controller being in a form selected from a group consisting of electromagnetic field, light, and acoustic wave.

9. A system with a zero power standby mode for controlling an electric appliance according to claim 1, the control signal receiving device further comprising a multi-switch section for selectively supplying electric power to the control instruction receiving section and the control signal processing section.

10. A system with a zero power standby mode for controlling an electric appliance according to claim 9, the multi-switch section being an SCR or a thyristor.

11. A system with a zero power standby mode for controlling an electric appliance according to claim 9, further comprising a power supply section connected to the multi-switch section for outputting power to the control instruction receiving section and the control signal processing section.

12. The zero power standby mode system for the electric appliances according to claim 11, the power supply section being selected from a group consisting of a battery, a solar cell, a capacitor, and an alternating current-to-direct current converting circuit.

13. A system with a zero power standby mode for controlling an electric appliance according to claim 1, further including the electric appliance.

14. A system with a zero power standby mode for controlling an electric appliance according to claim 13, wherein the electric appliance is a television set.

15. A method of remotely controlling an electric appliance with a system comprising a remote controller including a power output section for outputting an activating signal and a control signal output section for outputting a control signal for controlling the electric appliance, the method comprising:
receiving an activating signal from the remote controller with a power receiving section of a control signal receiving device, wherein the power receiving section is configured to be readily activated using power transmitted by the activating signal without any need for a quiescent current;
using power received from the activating signal to direct electric power from a power supply to a control signal processing section and a control instruction receiving section of the control signal receiving device, thereby putting the control signal receiving device into a normal running mode;
receiving a control signal from the remote controller with the control instruction receiving section;
controlling the electric appliance to turn on the electric appliance while in the normal running mode if the control signal corresponds to a command to turn on the electric appliance; and
continuing supply of electrical power to the control signal processing section and the control instruction receiving section of the control signal receiving device until the control signal corresponds to a command to turn off the electric appliance.

16. A method according to claim 15, wherein using power received from the activating signal to direct electric power from a power supply comprises transmitting instructions for a multi-switch section to close a circuit from the power supply to the control signal processing section to provide power to the control signal processing section and the control instruction receiving section.

17. The method according to claim 15, further comprising:
sending out the activating signal with the remote controller; and
delaying for a certain amount of time before sending out the control signal, thereby enabling the control instruction receiving section to function in advance of receiving the control signal from the remote controller to turn on the electric appliance.

18. A system with a zero power standby mode for controlling an electric appliance, the system comprising:
a control signal receiving device operatively connected to the electric appliance, the control signal receiving device including:
a control instruction receiving section configured to receive a control signal output from a remote controller;
a control signal processing section configured to control the electric appliance in response to the control signal; and
a power receiving section configured to receive an activating signal from the remote controller and generate a wake-up command using power transmitted by the activating signal without any need for a quiescent current, the wake-up command configured to enter a run mode in which power is supplied to the control instruction receiving section and the control signal processing section, thereby enabling the control signal receiving device to receive the control signal and control the electric appliance.

19. A system with a zero power standby mode according to claim 18, wherein in the run mode, the control signal receiving device is configured to energize the electric appliance if the control signal comprises a turn-on signal, and to de-energize the electric appliance and enter a zero power standby mode if the control signal comprises a turn-off signal.

20. A system with a zero power standby mode according to claim 19, wherein the system is comprised by the electric appliance.

21. A system with a zero power standby mode according to claim 19, further comprising the remote controller, wherein the remote controller comprises a power output section for outputting the activating signal, and a control signal output section for outputting the control signal, and wherein the remote controller is configured to delay output of the control signal after outputting the activating signal to enable the control signal receiving device to enter the run mode.
